(19) United States
(12) Patent Application Publication
(10) Pub. No.: US 2024/0347808 A1
(43) Pub. Date: Oct. 17, 2024

(54) Battery Module and Manufacturing Method Thereof

(71) Applicant: LG Energy Solution, Ltd., Seoul (KR)

(72) Inventors: Min Yong Jung, Daejeon (KR); Bum Choi, Daejeon (KR); Jong Yoon Keum, Daejeon (KR); Soo Jun Ahn, Daejeon (KR); Jae Heon Chung, Daejeon (CN)

(73) Assignee: LG Energy Solution, Ltd., Seoul (KR)

(21) Appl. No.: 18/291,289

(22) PCT Filed: Jan. 4, 2023
(86) PCT No.: PCT/KR2023/000122

§ 371 Date: Jan. 23, 2024

(30) Foreign Application Priority Data
Jan. 4, 2022 (KR) 10-2022-0000843

(51) Int. Cl. H01M 10/6551; H01M 10/613; H01M 10/653; H01M 10/6556; H01M 10/6568; H01M 50/383

(52) U.S. Cl. CPC H01M 10/6551; H01M 10/613; H01M 10/653; H01M 10/6556; H01M 10/6568; H01M 50/383

(57) ABSTRACT

A battery module according to one example of the present invention includes at least one battery cell having a vent part, and a heat dissipation part disposed to face the vent part of the at least one battery cell to dissipate heat from the battery cell. The heat dissipation part includes a heat dissipation film, one side of which is attached to the battery cell to face the vent part of the battery cell, and a heat dissipation case coupled to the other side opposite to one side of the heat dissipation film to form a cooling flow passage.

### CROSS-REFERENCE TO RELATED APPLICATIONS

This application is a national phase entry under 35 U.S.C. § 371 of International Application No. PCT/KR2023/000122, filed Jan. 4, 2023, which claims the benefit of priority based on Korean Patent Application No. 10-2022-0000843 dated Jan. 4, 2022, all the disclosures of which are incorporated herein by reference in their entireties.

### TECHNICAL FIELD

The present invention relates to a battery module and a manufacturing method thereof, which relates to, specifically, a battery module capable of suppressing a flame of an ignited battery cell by a method that while a heat dissipation film is torn by a pressure to open a vent part of the battery cell upon internal ignition of the battery cell, cooling water flows down to the battery cell through the damaged portion of the heat dissipation film, and a manufacturing method thereof.

### BACKGROUND ART

FIG. 1 is a diagram for explaining, in a battery module according to the conventional technology, lateral ignition upon ignition of a battery cell.

In general, the battery module (10) comprises at least one battery cell (11) and a heatsink (12) attached to the battery cell (11). The heatsink (12) may be formed by attaching aluminum plates to each other by a brazing method or by attaching an aluminum plate to a plastic plate by a heterojunction method.

The battery cell (11) is provided with a vent part (11a). When the internal pressure of the battery cell increases, the vent part (11a) is designed to open prior to other parts of the battery cell (11). When ignition occurs inside the battery cell, the vent part (11a) is opened, and flames are ejected to the outside of the battery cell (11).

Referring to FIG. 1, as in the prior art, when the heatsink (12) is attached to the vent part (11a) side of the battery cell (11), the heatsink (12) blocks the vent part (11a) of the battery cell (11) upon ignition occurrence inside the battery cell (11), so that the vent part (11a) does not open upon the ignition of the battery cell (11).

If the vent part (11a) of the battery cell (11) is not opened, the internal pressure of the battery cell (11) is continuously increased to tear the side surface of the battery cell, whereby a phenomenon in which flames are ejected to the side surface of the battery cell occurs.

The flames ejected to the side surface of the battery cell (11) are transmitted to the battery cell (11) disposed adjacent thereto, thereby causing chain ignition.

### DISCLOSURE

### Technical Problem

The present invention is intended to provide a battery module capable of suppressing a flame of an ignited battery cell by a method that while a heat dissipation film is torn by a pressure to open a vent part of the battery cell upon internal ignition of the battery cell, cooling water flows down to the battery cell through the damaged portion of the heat dissipation film, and a manufacturing method thereof.

In addition, the present invention is intended to provide a battery module capable of preventing continuous ignition of battery cells, and a method for manufacturing the battery module.

### Technical Solution

A battery module according to one example of the present invention comprises at least one battery cell having a vent part, and a heat dissipation part, which is disposed to face the vent part of the at least one battery cell, for dissipating heat from the battery cell.

Also, the heat dissipation part comprises a heat dissipation film, one side of which is attached to the battery cell to face the vent part of the battery cell, and a heat dissipation case, which is coupled to the other side opposite to one side of the heat dissipation film, having a cooling flow passage through which cooling water flows.

In addition, the heat dissipation film may be provided to be damaged when the vent part of the battery cell is ignited.

Furthermore, the heat dissipation part may be provided so that the cooling water flowing through the cooling flow passage passes through the damaged portion of the heat dissipation film to flow to the vent part of the battery cell.

Also, the heat dissipation film may be a film in which a polymer resin film is compressed to an aluminum film.

In addition, the heat dissipation film may comprise a polypropylene (PP) film, an aluminum film, a nylon film, and a polyethylene terephthalate (PET) film. In this case, a polypropylene (PP) film, an aluminum film, a nylon film, and a polyethylene terephthalate (PET) film may be sequentially laminated to form a heat dissipation film.

Furthermore, the heat dissipation case may have a film coupling part coupled to the heat dissipation film, and at least one flow passage groove provided stepwise with respect to the film coupling part. In this case, the heat dissipation film surrounds the at least one flow passage groove, and the cooling flow passage may be provided in a space between the at least one flow passage groove and the heat dissipation film.

Also, the at least one flow passage groove may comprise a reference groove, and a plurality of branch grooves branched from the reference groove.

In addition, the heat dissipation part may comprise a port connected to the flow passage groove to enable fluid migration and provided in the heat dissipation case, and a cooling unit connected to the port and provided to supply or recover cooling water through the port.

Furthermore, the heat dissipation case may be formed of a synthetic resin.

Also, the synthetic resin may comprise a polypropylene (PP)-based resin.

In addition, according to another aspect of the present invention, as a method for manufacturing the battery module, a method for manufacturing the battery module comprising steps of molding a heat dissipation case having a cooling flow passage by a vacuum injection method, and thermally compressing a heat dissipation film to the heat dissipation case is provided.

Furthermore, the manufacturing method of the battery module may comprise a step of coupling a heat dissipation film to the battery cell such that a partial region of the vent part of the battery cell is located on the cooling flow passage.

Also, the heat dissipation film may be formed by sequentially laminating a polypropylene (PP) film, an aluminum film, a nylon film, and a polyethylene terephthalate (PET) film.

In addition, the heat dissipation case may comprise a polypropylene (PP)-based resin.

### Advantageous Effects

As described above, the battery module related to at least one example of the present invention, and a manufacturing method thereof have the following effects.

It is possible to early suppress a flame of an ignited battery cell by a method that while a heat dissipation film is torn by a pressure to open a vent part of the battery cell upon internal ignition of the battery cell, cooling water flows down to the battery cell through the damaged portion of the heat dissipation film.

Also, it is possible to secure safety of the battery module by suppressing an increase in temperature of the ignited battery cell and the battery cells adjacent thereto.

In addition, as the heat dissipation film is formed in the form of a thin film by the micrometer, the heat dissipation film can be torn by the force of opening the vent part upon internal ignition of the battery cell. As a result, lateral explosion of the battery cell can be prevented, and thus, chain ignition of the battery cell can be prevented.

### DESCRIPTION OF DRAWINGS

FIG. 1 is a diagram for explaining, in a battery module according to the conventional technology, lateral ignition upon ignition of a battery cell.

FIG. 2 schematically illustrates a perspective diagram of a battery module according to one example of the present invention.

FIG. 3 schematically illustrates a cross-sectional diagram of a battery module according to one example of the present invention.

FIG. 4 schematically illustrates a combined cross-section of a heat dissipation case and a heat dissipation film according to one example of the present invention.

FIG. 5 schematically illustrates a cross section of a heat dissipation film according to one example of the present invention.

FIG. 6 schematically illustrates a combined cross-section of a heat dissipation part and a battery cell according to one example of the present invention.

FIG. 7 is a diagram for explaining, in a battery module according to one example of the present invention, a process of suppressing a flame of a battery cell while cooling water is discharged from a heat dissipation part upon internal ignition of any one battery cell.

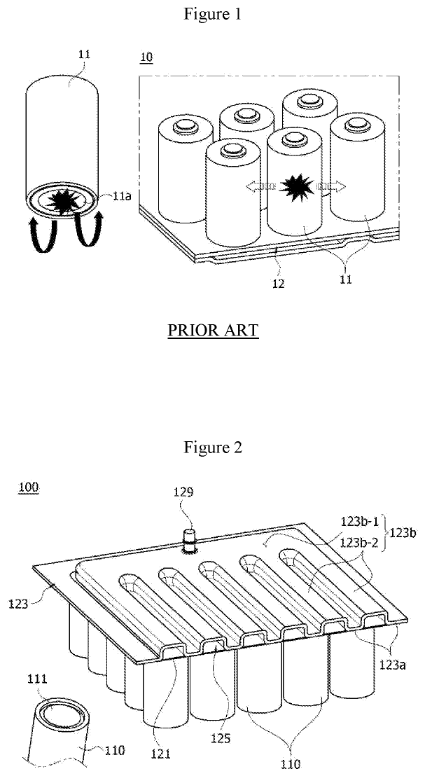

### DETAILED DESCRIPTION

Hereinafter, a battery module according to one example of the present invention, and a method for manufacturing the battery module will be described with reference to the accompanying drawings.

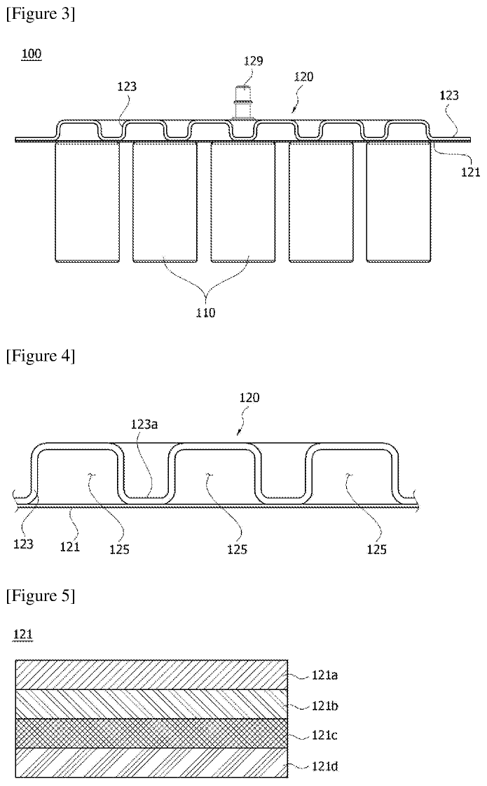

FIG. 2 schematically illustrates a perspective diagram of a battery module according to one example of the present invention, FIG. 3 schematically illustrates a cross-sectional diagram of a battery module according to one example of the present invention, and FIG. 4 schematically illustrates a combined cross-section of a heat dissipation case and a heat dissipation film according to one example of the present invention.

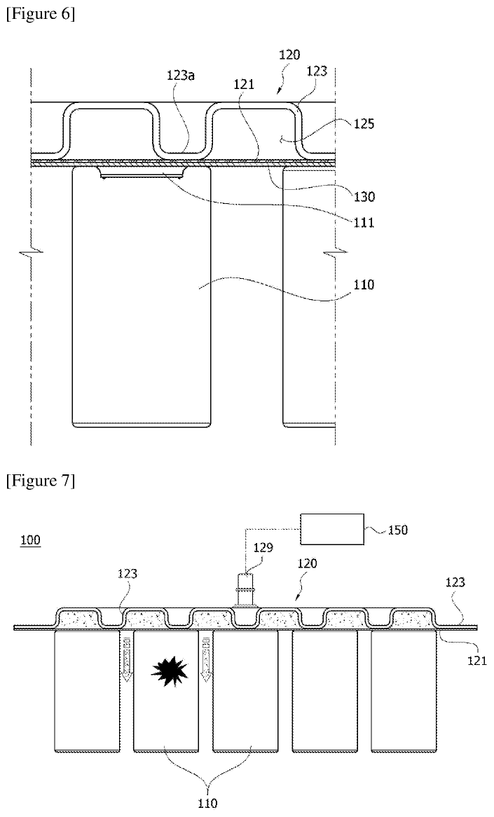

FIG. 5 schematically illustrates a cross section of a heat dissipation film according to one example of the present invention, FIG. 6 schematically illustrates a combined cross-section of a heat dissipation part and a battery cell according to one example of the present invention, and FIG. 7 is a diagram for explaining, in a battery module according to one example of the present invention, a process of suppressing a flame of a battery cell while cooling water is discharged from a heat dissipation part upon internal ignition of any one battery cell.

The battery module (100) according to one example of the present invention comprises at least one battery cell (110) and a heat dissipation part (120). The battery module (100) may comprise a plurality of battery cells (110).

Each battery cell (110) has a vent part (111). For example, the battery cell (110) may be a cylindrical battery cell (110), and may be embedded in a form that an electrode and a separator are wound therein. The vent part (111) is provided at one end of the battery cell (110). Since the battery cell (110) is a known product, a detailed description thereof will be omitted in this example.

In addition, the heat dissipation part (120) is disposed to face the vent parts (111) of the plurality of battery cells (110), and is provided to dissipate heat from the plurality of battery cells (110).

The heat dissipation part (120) comprises a heat dissipation film (121), one side of which is attached to the battery cell (110) to face the vent part (111) of the battery cell (110), and a heat dissipation case (123) coupled to the other side opposite to one side of the heat dissipation film (121) and having a cooling flow passage (125) through which cooling water flows.

As shown in FIGS. 3 and 4, the heat dissipation part (120) may comprise a heat dissipation film (121), a heat dissipation case (123), a port (129), and a cooling unit (150). The heat dissipation part (120) is disposed to face the vent part of at least one battery cell (110), and dissipates heat generated upon charging of the battery cell (110) through cooling water.

Also, the heat dissipation film (121) may be a film having insulation and heat dissipation properties. The heat dissipation film (121) may be a thin film having a thickness in a micrometer (μm) unit, and for example, the heat dissipation film (121) has a thickness of 10 μm to 900 μm.

In addition, the heat dissipation film (121) may be provided so that it is damaged when the vent part (111) of the battery cell (110) is ignited. At this time, the heat dissipation film (121) may be provided so that a local region directly facing the vent part (111) is partially damaged.

The heat dissipation part (120) may be provided so that the cooling water flowing through the cooling flow passage (125) passes through the damaged portion of the heat dissipation film (121) to flow to the vent part (111a) of the battery cell (110).

Also, the heat dissipation film (121) may be a film in which a polymer resin film is compressed on an aluminum film. Referring to FIG. 5, the heat dissipation film (121) may be a film in which a polypropylene (PP) film (121a), an aluminum film (121b), a nylon film (121c), and polyethylene terephthalate (PET) are sequentially laminated and compressed.

In addition, the heat dissipation case (123) may have a film coupling part (123a) coupled to the heat dissipation film (121), and at least one flow passage groove (123b) provided stepwise with respect to the film coupling part (123a). The heat dissipation case (123) surrounds at least one flow passage groove (123b) while the heat dissipation film (121) is thermally compressed to the film coupling part (123a), where the cooling flow passage (125) may be provided between the at least one flow passage groove (123b) and the heat dissipation film. That is, the flow passage groove (123b) is formed stepwise on the film coupling part (123a) and has a structure open toward the film coupling part (123a). At this time, the heat dissipation film (121) is coupled to the film coupling part (123a) to surround the open portion of the flow passage groove (123b), and forms the cooling flow passage together with the flow passage groove (123b).

At least one flow passage groove (123b) comprises a reference groove (123b-1), and at least one branch groove (123b-2) branched from the reference groove (123b-1). The heat dissipation part (120) may comprise a port (129) connected to the flow passage groove (123b) to enable fluid migration and provided in the heat dissipation case, and a cooling unit (150) connected to the port (127) and provided to supply or recover cooling water through the port. In addition, the port (129) may be installed in the reference groove (123b-1).

Here, each branch groove (123b-2) is connected to the reference groove (123b-1), and each branch groove (123b-2) may be provided to be partitioned from each other. At least one branch groove (123b-2) may be provided in parallel with the arrangement direction of the plurality of battery cells (110).

The heat dissipation case (123) may be formed of a synthetic resin. In addition, the heat dissipation case (123) may be injection-molded with a synthetic resin by a vacuum injection method. Here, the synthetic resin may comprise a polypropylene (PP)-based resin.

In this example, the heat dissipation case (123) and the heat dissipation film (121) are formed of a resin material. At this time, when the contact site between the heat dissipation case (123) and the heat dissipation film (121) is thermally compressed or thermally fused, the heat dissipation film (121) is coupled to the film bonding part (123a) of the heat dissipation case (123).

The port (129) is installed in the heat dissipation case (123). The port (129) is installed in the heat dissipation case (123) to enable fluid migration with the reference groove (123b-1). The port (129) is a passage through which cooling water flows into the cooling flow passage (125).

The port (129) may be coupled to the heat dissipation case (123) by any one of an adhesive, a heterojunction method, or a bolting method. A sealing treatment by a sealing member may be performed between the port (129) and the heat dissipation case (123).

The cooling unit (150) is connected to the port (129). The cooling unit is a device which supplies cooling water to the cooling flow passage or recovers cooling water in the cooling flow passage to the outside.

Referring to FIGS. 6 and 7, the heat dissipation part (120) is coupled to at least one battery cell (110) such that at least a partial region of the vent part (111) of the battery cell (110) is placed on the cooling flow passage (125). At this time, the heat dissipation part (120) may be coupled to the battery cell (110) by the adhesive (130).

In addition, the battery cell (110) may be attached to the heat dissipation part (120) such that an area placed on the film coupling part (123a) is minimized and an area facing the cooling flow passage (125) is maximized. This is to allow the vent part (111) of the battery cell (110) to be opened more easily upon internal ignition of the battery cell (110).

Referring to FIG. 7, while the vent part (111) of the battery cell (110) is opened upon internal ignition of the battery cell (110) and the heat dissipation film (121) is torn by the force that the vent part (111) pushes up the heat dissipation film (121), the cooling water flowing through the cooling flow passage (125) flows down to the ignited battery cell (110).

Accordingly, the present invention can suppress the flame of the ignited battery cell (110) early, suppress the temperature increase of the ignited battery cell (110) and the battery cells (110) adjacent thereto, and secure the safety of the battery module (100).

A method for manufacturing the battery module according to one example of the present invention will be described.

The manufacturing method of the battery module comprises steps of forming a heat dissipation case having a cooling flow passage by a vacuum injection method, and thermally compressing a heat dissipation film to the heat dissipation case.

In addition, the manufacturing method comprises a step of coupling a heat dissipation film to the battery cell so that a partial region of the vent part of the battery cell is located on the cooling flow passage.

Specifically, a heat dissipation case (123) provided with at least one flow passage groove (123b) is prepared (S1). The heat dissipation case (123) is prepared by the following process.

A mold (not shown) having a shape corresponding to the heat dissipation case (123) is prepared (S1-1). The mold preferably has a structure in which at least one flow passage groove (123b) implements the structure of the heat dissipation case (123) stepwise with respect to the film coupling part (123a).

A synthetic resin is introduced into the mold (S1-2). Here, the synthetic resin is preferably a polypropylene (PP)-based resin.

The synthetic resin is introduced into the mold, and then the mold is heated. Accordingly, the synthetic resin in the mold is softened (S1-3).

Thereafter, the synthetic resin is softened, and then the air in the mold is suctioned by a vacuum injection method. Through this process, in the mold, the softened synthetic resin is molded as in the shape of the mold, and manufactured into a heat dissipation case (S1-4).

Thereafter, the heat dissipation case is separated from the mold (S1-5).

Finally, an opening for a port is punched in the heat dissipation case (S1-6). Here, the opening for the port is an opening in which the port is installed.

Next, when the heat dissipation case (123) is prepared, a heat dissipation film (121) is coupled to the heat dissipation case (123) (S2, S3).

Here, the heat dissipation film (121) is a thin film having a thickness in a micrometer (μm) unit. As the heat dissipation film (121), a film in which a polypropylene (PP) film, an aluminum film, a nylon film, and a PET film are laminated and compressed may be used.

The heat dissipation film (121) is thermally compressed to the film coupling part (123a) of the heat dissipation case (123) while covering at least one flow passage groove (123b). As the heat dissipation film (121) is coupled to the heat dissipation case (123), the heat dissipation part (120) provided with the cooling flow passage (125) is manufactured (S3).

A port (129), which is a flow passage of cooling water, is installed in the heat dissipation case (123) (S4). The port (129) is inserted into an opening (not shown) for the port and fixed to the heat dissipation case (123) by an adhesive. Alternatively, the port (129) may be coupled to an opening (not shown) for the port by any one of a heterojunction method and a bolting method. Then, the gap of the port (129) with the heat dissipation case (123) is sealed by a sealing member.

The heat dissipation part (120) is coupled to at least one battery cell (110) such that the heat dissipation film (121) contacts the bottom surface of the at least one battery cell (110) (S5). In step S5, at least one battery cell (110) is preferably coupled to the heat dissipation part (120) such that a partial region of the vent part (111) of the battery cell (110) is placed on the cooling flow passage (125).

The preferred examples of the present invention as described above have been disclosed for illustrative purposes, and those skilled in the art having ordinary knowledge of the present invention will be able to make various modifications, changes, and additions within the spirit and scope of the present invention, and such modifications, changes, and additions should be regarded as falling within the scope of the following claims.

### INDUSTRIAL APPLICABILITY

According to a battery module related to at least one example of the present invention, and a manufacturing method thereof, it is possible to early suppress a flame of an ignited battery cell by a method that while a heat dissipation film is torn by a pressure to open a vent part of the battery cell upon internal ignition of the battery cell, cooling water flows down to the battery cell through the damaged portion of the heat dissipation film.

1. A battery module, comprising:
at least one battery cell having a vent part; and
a heat dissipation part, which is disposed to face the vent part of the at least one battery cell, for dissipating heat from the battery cell, wherein
the heat dissipation part comprises a heat dissipation film, one side of which is attached to the battery cell to face the vent part of the battery cell, and a heat dissipation case, which is coupled to the other side opposite to one side of the heat dissipation film, having a cooling flow passage through which cooling water flows.

2. The battery module according to claim 1, wherein
the heat dissipation film is configured to be damaged when the vent part of the battery cell is ignited.

3. The battery module according to claim 2, wherein
the heat dissipation part is provided so that the cooling water flowing through the cooling flow passage passes through the damaged portion of the heat dissipation film and flows to the vent part of the battery cell.

4. The battery module according to claim 1, wherein
the heat dissipation film is a film in which a polymer resin film is compressed to an aluminum film.

5. The battery module according to claim 1, wherein
the heat dissipation film comprises a polypropylene (PP) film, an aluminum film, a nylon film, and a polyethylene terephthalate (PET) film.

6. The battery module according to claim 1, wherein
the heat dissipation case has a film coupling part coupled to the heat dissipation film, and at least one flow passage groove provided stepwise with respect to the film coupling part,
the heat dissipation film surrounds the at least one flow passage groove, and
the cooling flow passage is provided in a space between the at least one flow passage groove and the heat dissipation film.

7. The battery module according to claim 6, wherein
the at least one flow passage groove comprises a reference groove, and a plurality of branch grooves branched from the reference groove.

8. The battery module according to claim 6, wherein
the heat dissipation part further comprises a port provided in the heat dissipation case and connected to the at least one flow passage groove to enable fluid migration, and a cooling unit connected to the port and provided to supply or recover cooling water through the port.

9. The battery module according to claim 5, wherein
the heat dissipation case is formed of a synthetic resin.

10. The battery module according to claim 9, wherein
the synthetic resin comprises a polypropylene (PP)-based resin.

11. A method for manufacturing the battery module according to claim 1, wherein the method for manufacturing the battery module comprises steps of:
molding a heat dissipation case having a cooling flow passage by a vacuum injection method; and
thermally compressing a heat dissipation film to the heat dissipation case.

12. The method for manufacturing the battery module according to claim 11, further
comprising a step of coupling a heat dissipation film to the battery cell such that a partial region of the vent part of the battery cell is located on the cooling flow passage.

13. The method for manufacturing the battery module according to claim 11, wherein
the heat dissipation film comprises a polypropylene (PP) film, an aluminum film, a nylon film, and a polyethylene terephthalate (PET) film.

14. The method for manufacturing the battery module according to claim 11, wherein
the heat dissipation case comprises a polypropylene (PP)-based resin.
